(19) United States
(12) Patent Application Publication
(10) Pub. No.: US 2024/0343909 A1
(43) Pub. Date: Oct. 17, 2024

(54) HIGH TEMPERATURE HEAT INTEGRATION METHOD OF MAKING CARBON BLACK

(71) Applicant: Monolith Materials, Inc., Lincoln, NE (US)

(72) Inventors: Peter Louis Johnson, Mountain View, CA (US); Roscoe W. Taylor, Kingwood, TX (US)

(21) Appl. No.: 18/581,888

(22) Filed: Feb. 20, 2024

Related U.S. Application Data
(63) Continuation of application No. 15/241,771, filed on Aug. 19, 2016, now Pat. No. 11,939,477.
(60) Provisional application No. 62/209,017, filed on Aug. 24, 2015.

(51) Int. Cl. C09C 1/48; B01J 19/08; C01B 32/05

(52) U.S. Cl. CPC C09C 1/485; B01J 19/088; C01B 32/05; C09C 1/48; B01J 2219/0871; B01J 2219/0883; B01J 2219/0898

(57) ABSTRACT

A high temperature heat integration method of making carbon black. A method of making carbon black is described, including reacting a carbon black forming feedstock with hydrogen gas in a plasma reactor to produce effluent gas containing carbon black and unused hydrogen, cooling the effluent gas for further processing, and recycling the unused hydrogen back into the carbon black forming process, where the unused hydrogen gas is pre-heated in a heat exchanger to a temperature up to the reaction temperature in the reactor before being recycled into the carbon black forming process. The heat exchanger for use in such process is also described.

### CROSS-REFERENCE TO RELATED APPLICATIONS

The present application claims priority of U.S. Provisional Application No. 62/209,017 filed Aug. 24, 2015, which may relate to subject matter disclosed in U.S. patent application Ser. No. 14/591,476, filed Jan. 7, 2015, which application claims the benefit under 35 U.S.C. § 119(e) of U.S. Provisional Application No. 61/933,497 filed Jan. 30, 2014. The entirety of each of the aforementioned applications is specifically incorporated herein by reference for all purposes.

### TECHNICAL FIELD

The field of art to which this invention generally pertains is methods and apparatus for making use of electrical energy to affect chemical changes.

### BACKGROUND

There are many processes that can be used and have been used over the years to produce carbon black. The energy sources used to produce such carbon blacks over the years have, in large part, been closely connected to the raw materials used to convert hydrocarbon containing materials into carbon black. Residual refinery oils and natural gas have long been a resource for the production of carbon black. Energy sources have evolved over time in chemical processes such as carbon black production from simple flame, to oil furnace, to plasma, to name a few. As in all manufacturing, there is a constant search for more efficient and effective ways to produce such products. Varying flow rates and other conditions of energy sources, varying flow rates and other conditions of raw materials, increasing speed of production, increasing yields, reducing manufacturing equipment wear characteristics, etc. have all been, and continue to be, part of this search over the years.

The systems described herein meet the challenges described above, and additionally attain more efficient and effective manufacturing process.

### BRIEF SUMMARY

A heat exchanger particularly adapted for use in a plasma carbon black generating process is described, including a block of high temperature stable material, containing at least one first and at least one second independent fluid flow passageways through the material, and wherein the material can withstand sustained temperatures generated in a plasma carbon black generating process.

Additional embodiments include: the heat exchanger described above where the at least one first passage way has a diameter larger than that of the at least one second passage way; the heat exchanger described above where the material can withstand sustained temperatures of at least 1200° C.; the heat exchanger described above including multiple blocks of material integrally connected and stacked one on top of the other, where the at least one first passageway in each block of material is in fluid flow communication with the at least one first passageway in the other blocks of material, and the at least one second passageway in each block of material is in fluid flow communication with the at least one second passageway in the other blocks of material, and wherein the blocks of material are sealed so as to prevent any substantial loss of fluid between the individual blocks of material during use; the heat exchanger described above where the block of material comprises at least one of graphite, silicon carbide, a refractory metal, or high temperature ceramic material; the heat exchanger described above where the at least one first passageway has a diameter of at least 3 inches; the heat exchanger described above further contained in a insulated shell material; the heat exchanger described above where the blocks are compressed together by one or more vessel expansion joints; the heat exchanger described above where the block of material includes at least one material unable to withstand an oxidant containing stream at the sustained temperatures.

A method of making carbon black is also described, including reacting a carbon black forming feedstock with a hydrogen containing gas in a plasma reactor to produce effluent gas containing carbon black hydrogen and other constituents of the feedstock and plasma gas, recovering heat from the effluent gas for further processing, and recycling a portion of the hydrogen and other constituents of the feedstock and plasma gas back into the carbon black forming process, where the recycled portion of the hydrogen and other constituents of the feedstock and plasma gas are pre-heated in a heat exchanger to a temperature up to the reaction temperature before returning to the carbon black forming reactor.

Additional embodiments include: the method described above where the recycled hydrogen containing gas is preheated to a temperature of at least 1200° C.; the method described above where the recycled hydrogen is preheated to a temperature up to about 2500° C.; the method described above where the recycled hydrogen containing gas is preheated in the heat exchanger with effluent gas; the method described above where the heat exchanger additionally cools the effluent gas down to a temperature of 1000° C. or less; the method described above where the effluent gas is cooled in the heat exchanger by the hydrogen containing gas being recycled; the method described above where in the heat exchanger the hydrogen containing gas is at a higher pressure than the effluent gas; the method described above where in the heat exchanger the effluent gas flows in a direction opposite or counter current to that of the hydrogen containing gas; the method described above where in the heat exchanger the effluent gas flows in a direction cross-flow to that of the hydrogen containing gas; the method described above where the amount of hydrogen gas introduced into the heat exchanger is in excess of that required for heating and/or cracking the feedstock.

These and additional embodiments are further described below.

### BRIEF DESCRIPTION OF THE DRAWINGS

FIG. 1 depicts a typical furnace black process.

FIG. 2 depicts a plasma black process.

FIG. 3 depicts a plasma black process including the use of a heat exchanger embodiment described herein.

FIG. 4a, 4b and 4c depict heat exchanger embodiments described herein.

FIG. 5 depicts a vessel containing a heat exchanger embodiment described herein.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

The system and processes described herein use a heat exchanger constructed of a high temperature stable materials, for example, non-metallic materials, such as graphite, silicon carbide, or high temperature ceramics such as alumina, and/or a refractory metal, such as tungsten, which can pre-heat recycled hydrogen containing gas in the plasma based carbon black process up to temperatures approaching reaction temperature in the reactor, specifically 1200° C. or higher, significantly reducing the electrical production load—MWh (mega-watt hours)/metric ton produced—of the process, as well as significantly reducing the size and capital expenses of downstream equipment in the recycle loop, including the product cooler, main unit filter, blower/compressor, and/or gas cleanup membrane system. This represents a significant integration of a high temperature stable material heat exchanger in a carbon black process with reactor gas effluent inlet temperatures above 1200° C. The system described herein can utilize inlet temperatures up to about 2500° C., with the sublimation or melting temperature of the heat exchanger material being the only limitation.

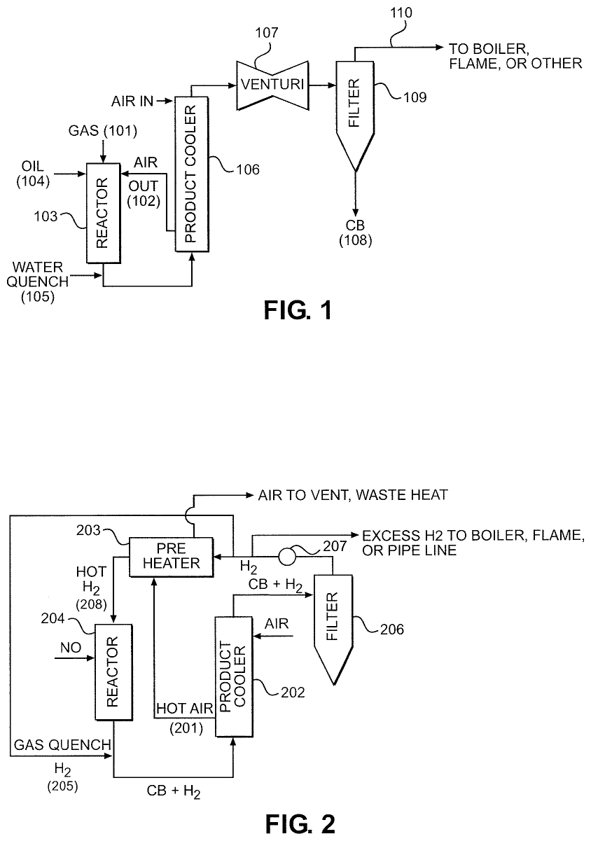

In typical furnace black production (shown in FIG. 1, for example), natural gas (101) is combusted with hot air (102) in the first section of a reactor (103), after which oil (104) is injected into the process, consuming the remaining air with the excess oil then cracking to form carbon black. The resulting tail gas, substantially comprising nitrogen, water vapor, carbon monoxide, hydrogen and other constituents known to those skilled in the art, and suspended carbon black is first cooled/quenched (stopping reaction) with a water quench spray (105), then in an air cooled product cooler (106), and finally with a venturi mixer (107) with more water prior to entering a main unit filter. Many known processes reduce the water injected with other heat recovery methods such as raising steam, heating the oil feedstock and others, so as not to waste the heat by evaporating water. The carbon black (108) drops through the bottom of the filter vessel (109) while the tail gas (110) is then conveyed to an end use, such as drying the product (wet process pelletization), a boiler or flare, or used otherwise in heat integration into the process such as firing a—oil feedstock heater. Hot air (102) from the product cooler is then used to fire the reactor burner, whose effluent then combusts and cracks the oil feedstock. The hotter this air is when entering the burner, the higher the efficiency of the reactor as the higher preheat reduces the natural gas consumption and increases the yield and throughput of the process. Typical air exit temperatures from product coolers are 650-800° C., though some newer plants use 950° C. air, achieving moderately better efficiencies, and future advances in technology may increase this limit further as metal technology continues to develop.

FIG. 2 depicts a plasma black process that cools the product to the filter temperature operating limit using a conventional air based heat exchanger (i.e., following the design of the heat exchanger shown in FIG. 1). The resulting hot air is then partially or wholly used to preheat the hydrogen used in the reactor, limiting the hydrogen temperature to less than that of the hot air, typically about 1000° C. Although there are no current plasma carbon black processes that operate this way, as depicted in FIG. 2, hot air (201) from the product cooler (202) is used to pre-heat (203) recycled hydrogen that is then conveyed into the plasma burner (204). The hotter the hydrogen is going into the plasma burner, the less electricity is consumed heating it up to its final temperature. Utilizing 900° C. air from the product cooler exhaust, for example, might make it possible to pre-heat the hydrogen containing plasma gas to around 800° C. When compared to not pre-heating the plasma gas and operating with a 3000° C. plasma, an 800° C. pre-heated stream of hydrogen could possibly require between 10-15% less electricity to achieve the same final temperature.

With the plasma design systems and methods described herein, recycled hydrogen can use the same plasma system described above, or could heat the hydrogen with the reactor effluent. These systems, using conventional metal heat exchangers, would still only deliver at most the same 950° C. preheat temperature used in the furnace process, rather than the up to 2500° C. that the heat exchangers as described herein may achieve.

As an additional benefit, the volume of gas required to be recirculated can be significantly reduced with the system described herein. The current plasma design referenced above uses recycled process gas (205) to quench the carbon black and hydrogen flow as it exits the reactor, reducing its temperature to within the inlet temperature limits (1050° C.) of conventional product coolers (202). Typically this quench flow is 1.5 times greater than the volume of plasma gas required. This volume of gas is then required to be cooled along with the products in the product cooler (202), filtered in the main unit filter (206), and compressed by the blower (207), increasing the size and power requirements of all of those downstream pieces of equipment.

Due to the dependency on electricity usage in heating hydrogen, pre-heating of the hydrogen is a strong lever to reducing total cost of production in the electric/natural gas production process. Previous efforts stopped short of doing a full heat integration, instead electing to reduce the exiting carbon black and hydrogen temperature with water cooling, boilers or gas quenches, matching the limitations of the traditional furnace process. The processes and systems described herein, instead takes advantage of the lack of oxidants in this plasma process which enables the use of unconventional materials that cannot survive an oxidant containing gas stream, such as ceramics like graphite, silicon carbide and refractory metals (tungsten, niobium, chrome etc). It also enables the use of materials with less than perfect sealing. In the furnace process this would result in air leaking into the tail gas and could create a destructive fire in the heat exchanger. Leaking the hydrogen containing plasma gas into the reactor effluent gasses creates no fire and so enables the use of materials which would otherwise have such sealing problems—for example alumina, magnesia, and chromium based refractories.

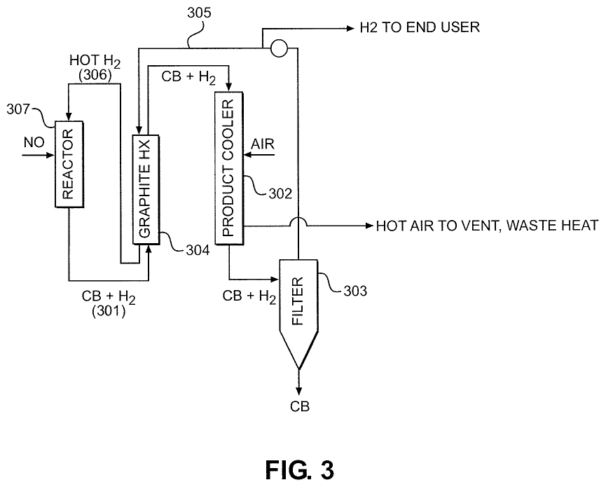

FIG. 3 depicts a plasma black process including the use of a heat exchanger embodiment enabling a much higher hydrogen temperature due to the higher temperature limits of the high temperature heat exchanger described herein. As described, a block heat exchanger (304) made from high temperature stable material that can operate at temperatures exceeding that of conventional metal heat exchangers, is used to cool the carbon black and effluent gasses (301) exiting the reactor (307) down to 1000° C. or less, where it can then enter a standard carbon black product cooling heat exchanger (302) or be filtered without such an exchanger. The coolant in the high temperature heat exchanger is the recycled hydrogen containing gas stream (rH₂ Stream (305)) which is at higher pressure than the carbon black/effluent gas product stream (CBH₂ stream (301)). The higher pressure is higher than what is coming out of the reactor so that any leak is into the reactor effluent gas rather than the other way around, which could then otherwise put carbon particles into parts of the system not designed to handle particles. Due to the superior heat transfer properties of hydrogen, the approach temperature of the cooling fluid can shrink relative to other systems increasing the maximum preheat of the hydrogen containing plasma gas stream (the approach temperature is the smallest temperature difference, either at the cold end of the heat exchanger (incoming plasma gas to be heated and effluent discharge temperature) or the hot end (incoming effluent and heated plasma gas temperature).

By using materials with a sufficiently high melting or sublimation point, for example graphite, the electric heating only needs to provide the enthalpy required to crack the natural gas, rather than that required to heat the plasma gas to the reaction temperature from the temperature required to compress or filter the plasma gas. In an ideal system for producing carbon black from natural gas, only the bond dissociation energy of methane would be required. However, to produce target grades of carbon black, the methane must be heated up to target reaction temperatures in excess of 1200° C. The closer this high temperature heat recovery (HTHR) system gets to re-heating the hydrogen to the reaction temperature required to make the desired carbon black quality, the closer the system gets to being that ideal system.

As described above, the HTHR system also either eliminates or significantly reduces the need for a quench gas at the outlet of the reactor. The required cooling load for the product cooler is also reduced by up to approximately 50%. Similarly, the required surface area sizing of the main unit filter (303, for example) is also reduced by up to approximately 50% and the required flow rate through the blower/compressor/gas cleaning system downstream of the filter is also reduced by a similar amount.

Two important requirements for the heat exchanger that cools the carbon black conveyed in the gas stream are (1) large diameter flow paths for the carbon black stream to prevent blockage and build up; and (2) low temperature differential between the material walls and the carbon black stream to prevent thermophoresis. While any diameter and temperature differential for the carbon black channels in the heat exchanger may be used which prevent blockage and carbon black build up in use, diameters of at least 3 inches and temperature differences between material and fluid of 300° C. or less have been found to be particularly useful. And while the carbon black channels can be the same size as the cooling channels, or even smaller, having the carbon black conveying channels of a larger diameter enables those channels to run cooler than if they were the same size as the cooling channels. In running cooler they should foul less and so enable a higher heat flux and smaller heat exchanger for a given heat duty. The diameter of the coolant fluid channel selected will of course depend on such things as relative fluid flow rates, material selected etc., so as to maintain a warm enough tube wall temperature in the carbon black fluid channels so as to eliminate or reduce the thermophoretic fouling from the presence of the carbon black particles. Representative diameters could be for example, 4 inches, 3 inches 2 inches, one inch, 0.5 inch, etc.

Similarly, the overall length and diameter of the heat exchangers used will depend on the size or scale of the process. Its internal surface area would be proportional to the production rate. For example, for small reactors as few as 30 carbon black flow channels could be sufficient, whereas commercial size units may require 144 carbon black flow channels or more.

To take advantage of the system described herein, at least a portion of the carbon black laden gas coming out of the reactor, and in most cases all of the carbon black laden gas coming out of the reactor, will be channeled through the heat exchangers described herein, which will then exchange heat with one or more other streams to preheat the other materials used in the process, or other fluid streams that utilize energy in the plant such as making steam, generating electricity, drying the product or other systems that can utilize heat.

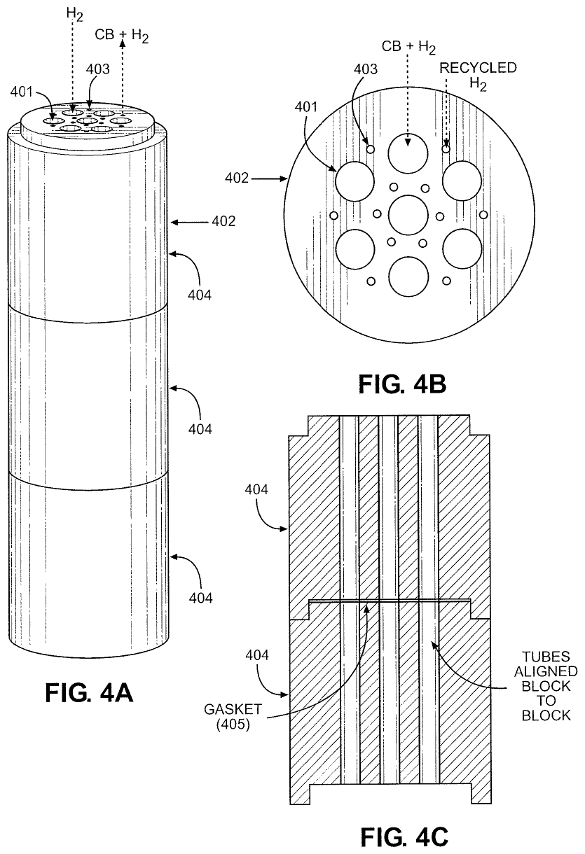

The HTHR system described herein (see, for example, FIGS. 4a, 4b and 4c) utilizes the CBH₂ stream flowing through at least 2 inch diameter holes or channels (401) in a block (402), while the rH₂ stream would flow through the same size or smaller diameter holes (403) in a counter or cross (i.e., perpendicular to the effluent channels) flow direction so as to limit the cooling of the surfaces in contact with the reactor effluent and so limit thermophoresis fouling. By using a block heat exchanger as opposed to a tube in shell design, for example, the design can incorporate a much larger heat exchange surface for the potentially fouling carbon black containing stream when compared to the heat exchange surface exposed to the highly conductive hydrogen containing plasma gas stream.

Using a counter flow arrangement will achieve minimum approach temperature of the rH₂ to the CBH₂ stream and minimum exit temperature of the CBH₂ stream, but other flow arrangements, such as cross flow, would also work.

With the system and methods described herein, multiple identical blocks (404) can be stacked on top of one another with a keyed fit and with a graphite gasket (405) or other high temperature material gasket sealing the mating surfaces. Due to the similar chemical composition of each stream even an imperfect seal would be sufficient. The individual blocks would be aligned (406) so as to provide continuous fluid flow from the holes or channels from one block to the next.

The rH₂ stream would be held at higher pressure than the CBH₂ stream, ensuring that if any leakage or communication did occur between the streams, it would be with clean rH₂ going into the CBH₂ stream, which would have negligible impact on the process conditions and maintain the rH₂ system free of carbon black.

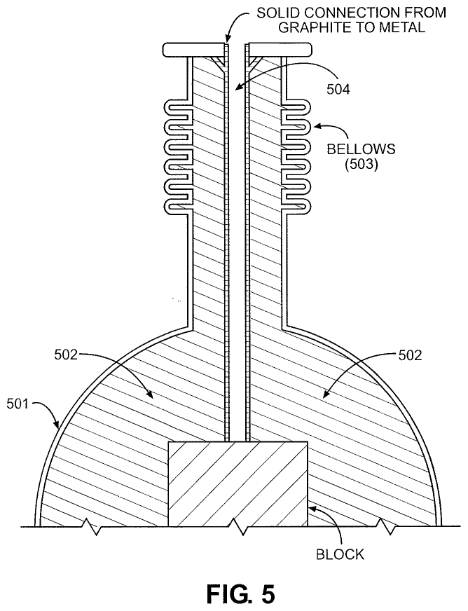

As described herein, the heat exchanger block stack could be contained (see, for example, FIG. 5) within a pressure containing vessel (501) constructed of metal, with high temperature insulation (502) between the heat exchange material and the containment shell protecting the metal from the block temperature and also constraining and aligning the blocks. The blocks may be compressed downward using a vessel expansion joint (503) that will maintain the required compressive forces to seal the joints between the blocks both when hot or cold. High temperature, for example, graphite and/or ceramic insulation would also protect the expansion joints from high temperatures. There could also be more than one vertically extending pipe (504) coming in and out of the metal vessel for the two streams.

The thermal mass of reactor effluent will always exceed that of the recycled hydrogen, as the reactor generates black and additional hydrogen. Consequently, the system as described herein, will always result in a larger temperature increase in the rH₂ stream than the drop in the CBH₂ stream. The result of this is that the cold end of the heat exchanger will have a larger temperature difference than the hot end.

In one embodiment, flowing more rH₂ than is needed by the process can eliminate this increasing temperature difference, and serve as a variable to maintain a constant temperature difference along the length of the exchanger, and in doing so minimize thermophoretic fouling. The plasma gas temperature will depend on the discharge temperature of the blower. The hot temperature will depend on the materials of the heat exchanger. The higher the hot temperature and the lower the blower discharge temperature the less the % of flow increase. Preferably the additional hydrogen will form a separate stream that can then realize value from the additional heat when the surplus stream gets sold as a fuel, or used to heat something else. Even if the heat gets rejected to atmosphere the benefit in terms of the heat exchanger operation and the impact on fouling should make this feature valuable.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1.-19. (canceled)

20. A heat exchanger system, comprising:
a heat exchanger comprising a first inlet configured to receive an effluent gas stream produced from a hydrocarbon feedstock in a plasma reactor, the effluent gas stream comprising carbon particles and hydrogen;
a separator configured to separate at least a portion of the hydrogen from the effluent gas stream, thereby obtaining a separated hydrogen gas stream;
wherein the heat exchanger comprises a second inlet configured to receive the separated hydrogen gas stream;
wherein the heat exchanger is configured to preheat the separated hydrogen gas stream, thereby obtaining preheated hydrogen; and
wherein the heat exchanger comprises an outlet configured to provide the preheated hydrogen to the plasma reactor.

21. The heat exchanger system of claim 20, wherein the heat exchanger is configured to preheat the separated hydrogen gas stream to a temperature of at least 1200° C.

22. The heat exchanger system of claim 20, wherein the heat exchanger system is configured to additionally cool the effluent gas stream down to a temperature of 1000° C. or less.

23. The heat exchanger system of claim 20, wherein the heat exchanger system is configured to hold the separated hydrogen gas stream at a higher pressure than the effluent gas stream.

24. The heat exchanger system of claim 20, wherein the heat exchanger is configured such that the effluent gas stream can flow in a direction counter-current to that of the separated hydrogen gas stream.

25. The heat exchanger system of claim 20, wherein the high temperature heat exchanger is configured such that the effluent gas stream can flow in a direction cross-flow to that of the separated hydrogen gas stream.

26. The heat exchanger system of claim 20, wherein the heat exchanger comprises at least one block comprising a first and a second independent fluid flow passageways therethrough, wherein the first independent fluid flow passageway has a diameter larger than that of the second independent fluid flow passageway.

27. The heat exchanger system of claim 26, wherein the first independent fluid flow passageway has a diameter of at least 3 inches.

28. The heat exchanger system of claim 20, wherein the heat exchanger comprises at least one of graphite, silicon carbide, refractory metal or high temperature ceramic material.

29. The heat exchanger system of claim 28, wherein the heat exchanger is configured to maintain a temperature differential between a wall comprising the at least one of graphite, silicon carbide, refractory metal or high temperature ceramic material and the effluent gas stream of no more than 300° C.

30. The heat exchanger system of claim 20, wherein an amount of the separated hydrogen gas stream introduced into the high temperature heat exchanger is in excess of that required for heating and/or cracking the hydrocarbon feedstock in the plasma reactor.

31. The heat exchanger system of claim 20, wherein the carbon particles of the effluent gas are produced by reacting the hydrocarbon feedstock with the preheated hydrogen in the plasma reactor.

32. The heat exchanger system of claim 20, wherein the separator is or comprises a filter.

33. A heat exchanger adapted for use in a plasma carbon black generating process, the heat exchanger comprising:
multiple blocks integrally connected and stacked one on top of the other;
wherein the multiple blocks comprise a first and a second independent fluid flow passageways through the multiple blocks;
wherein the multiple blocks can withstand a sustained temperature generated in the plasma carbon black generating process;
wherein the first independent fluid flow passageway in each block is in fluid flow communication with the first independent fluid flow passageway in the other blocks;
wherein the second independent fluid flow passageway in each block is in fluid flow communication with the second independent fluid flow passageway in the other blocks; and
wherein the blocks are sealed so as to prevent any substantial loss of fluid between the individual blocks during use.

34. The heat exchanger of claim 33, wherein the first independent fluid flow passageway has a diameter larger than that of the second independent fluid flow passageway.

35. The heat exchanger of claim 33, wherein the sustained temperature is at least 1200° C.

36. The heat exchanger of claim 33, wherein at least one block of the multiple blocks comprises at least one of graphite, silicon carbide, refractory metal or high temperature ceramic material.

37. The heat exchanger of claim 33, wherein the first independent fluid flow passageway has a diameter of at least 3 inches.

38. The heat exchanger of claim 33, wherein the heat exchanger is contained in a high temperature insulated shell material.

39. The heat exchanger of claim 33, wherein the multiple blocks are compressed together by one or more vessel expansion joints.
